(19) United States
(12) Patent Application Publication
(10) Pub. No.: US 2016/0098522 A1
(43) Pub. Date: Apr. 7, 2016

(54) METHOD AND SYSTEM FOR CREATING AND MANAGING PERMISSIONS TO SEND, RECEIVE AND TRANSMIT PATIENT CREATED HEALTH DATA BETWEEN PATIENTS AND HEALTH CARE PROVIDERS

(71) Applicant: David Roey Weinstein, Danville, CA (US)

(72) Inventor: David Roey Weinstein, Danville, CA (US)

(21) Appl. No.: 14/875,968

(22) Filed: Oct. 6, 2015

Related U.S. Application Data
(60) Provisional application No. 62/060,747, filed on Oct. 7, 2014.

(51) Int. Cl. G06F 19/00; H04L 12/58

(52) U.S. Cl. CPC G06F 19/322; H04L 51/04

(57) ABSTRACT

The recent explosion in the number of consumer devices able to read and transmit remote patient health data has provided a technical foundation for health care providers to cost effectively monitor chronically ill patients when they are not at the providers places of practice. In an embodiment of the invention, an invitation from a health care provider to share patient created health data is offered to a patient who may accept or reject said invitation. Furthermore, at any time subsequent to the acceptance of said invitation by said patient, either party may elect to revoke its agreement to share data established through said invitation offer and acceptance process. Using the invention, patients and providers may manage permissions to share patient created health data to meet their privacy and business needs and systems that facilitate communications of patient created health data can use these permissions to meet the needs of users.

### CROSS REFERENCE TO RELATED APPLICATIONS

This application claims priority to U.S. provisional patent application Ser. No. 62/060,747, filed Oct. 7, 2014, which application is incorporated herein in its entirety by this reference thereto.

### FIELD OF THE INVENTION

This invention relates to the field of health care information exchange. More specifically, the invention comprises computer implemented methods and systems to allow health care providers and patients to manage the types of remote health care data they wish to share with each other, and with whom they wish to subsequently stop sharing said data.

### BACKGROUND OF THE INVENTION

In recent years, a plethora of devices and software applications have come to market that have the capacity to read and transmit patient created health data and other data to health care providers emanating from a variety of remote sources including but not limited to patients' mobile (aka “smart”) phones, web sites, web based computer programs used by patients and devices attached to or communicating with patients' bodies, sometimes called “wearable devices”. According to a report published by ABI Research, there are expected to be 100 million wearable health devices to be shipped in next five years. However, while certain said patient created data is extremely valuable to physicians and other providers in managing patients with chronic illnesses, other patient created data is not.

By way of illustration, a device called Fitbit sold by Fitbit Inc. measures how many steps a person takes over a given period of time and can upload related data to the web. Many users of the Fitbit are young, healthy people. While some or many of them would like to send their data to their physicians, their physicians may not want to receive said data. Said data is unlikely to inform physicians in any meaningful way that would help him/her improve these patients' health outcomes. In fact, said data becomes a net liability to physicians who may feel morally or legally obligated to review any data received from patients. Yet for a minority of Fitbit users, there may be meaningful value to physicians in receiving “such step data” about patients' physical activity over a period of time.

Conversely, Glooko Inc. distributes a device called Glooko that measures a patient's blood glucose levels and can upload that data to the web. Monitoring blood glucose levels is an important part of managing diabetes. It is likely that many of the patients using Glooko are patients whose blood glucose data their physicians would like to receive.

To further complicate the issue, a patient may own both a Glooko and a Fitbit, but his physician may only want one of the data types generated (i.e., either the blood glucose or the steps), but not both. This phenomenon can also occur with a single wearable device. For example, the Apple Watch from Apple Inc. measures both exercise and heart pulse. It may be the case that a physician would like to receive heart pulse data, but not exercise data, despite that fact that both data types are read and transmitted from the same device.

According to the Centers for Disease Control and Prevention, 117 million Americans suffer from at least one chronic illness. According to CVS Health, 75% of our health care dollars are allocated to the treatment of chronic diseases. In order to stem the rate of year over year increases in health care costs related to chronic illnesses, there is a great need to manage patients with these diseases in cost effective manner that produced desired health outcomes.

Coincidentally, market forces in the United States, including those stemming from the passage of the Affordable Care Act of 2010, have created entities such as Accountable Care Organizations, entities that strive to coordinate care for patients across a myriad of business entities and, in addition, have financial incentives to both change patient behaviors for the better and track patient data much more frequently than has been done in the past. In many cases, health care providers are part of these ACOs and therefore can realize financial rewards if they are able to provide good health outcomes for patients with chronic illnesses. While the monitoring of remote patient data may be a key element of the strategy to manifest effective management of these patients, it must be harnessed in a cost effective manner. Harnessing these data in a cost effective manner requires that there is a mechanism to filter out the “noisy data”: the healthcare data providers do not want. Such a mechanism would allow providers to focus on the data that can add value to their management of patients with chronic illnesses.

Furthermore, patients own their health data and require a mechanism to authorize the sharing of specific health data with specific providers if they are to adopt the concept of sharing their remotely created data in the first place.

Furthermore, both patients and providers require a mechanism to stop sharing or receiving specific data with each other at any point in time.

Therefore, what is needed to facilitate the adoption of the electronic sharing of patient created health data with providers are cost effective methods and systems in which (i) providers can invite patients to share specific types of health care data with them (ii) patients can accept or decline such invitations and (iii) both patients and providers can revoke their respective invitations or authorizations to share data at any time.

### DESCRIPTION OF RELATED ART

There are methods today used to create online invitations, facilitate acceptance and allow revocation at any time. Two well known services that employ online invitation mechanisms are those offered by Facebook Inc and Linked In Inc. With these services, an individual may invite another individual to “friend” him and the recipient of the invitation to be a “friend” may accept, reject or ignore the request. An acceptance of the request to be a friend on Facebook or Linked In results in each individual being able to see information posted by the other. This process continues until one of the friends or the individual elects to terminate the relationship, which either party may do at any time and without the permission of the other party.

However, these invitation acceptance and revocation methods with respect to sharing data are typically done at the individual level, not the data type level. In other words, they are not specific to a type of data or a subtype of data. An accepted invitation to be a “friend” on Facebook means that one friend can see the information and postings of another. But those rights are not restricted or qualified by the type of data posted.

Facebook does allows for different categories of friends (e.g. Family vs non-Family) to be treated differently with regard to access to postings and even allows for the customization of the list of people that can see one's posting of information. However, these authorizations are limited to an “up or down” status on the person level, without consideration of the type of information being posted. For example, one cannot concurrently elect to share information posted about sports with an individual but not share information about movies with that same individual. Furthermore, if all one posted was information on his likes of movies, one cannot elect to share just some of the movies he has posted about himself with any particular individual. For example, if a user of Facebook posts in his profile that he likes the movies “The Sound of Music” and “Mary Poppins”, Facebook does not allow him to share his like of “The Sound of Music” without also sharing his like of “Mary Poppins”.

One may also wonder if the invention described herein is merely no more than a recitation of generic computer structure that serves to perform generic computer functions, and functions that are well-understood, routine, and conventional (i.e. receiving, establishing, creating, revoking and transmitting invitations). However, the invention is, in fact, quite novel. To applicant's knowledge, the practice of setting up a system via an invitation process to establish, record and manage permissions to transmit and receive patient created health data, including specific types of patient created health data, from patients to providers has never been done, manually or via a computer. This element, hence, is different from the elements in cases such as Bilski v. Kappos, 561 U.S. 593 (2010) or Alice Corp. v. CLS Bank Int'l, 573 U.S. ______ (2014) where the claims recited a pre-existing, fundamental economic or financial practice in our system of commerce. Bilski and Alice were, in a way, computerized adaptations of well-known practices such as hedging and intermediate settlement. By comparison, the paradigm of the reading, transmission and receipt of patient health data created and read outside the four walls of the provider's place of practice is very nascent. The invention is not an “abstract idea” within the meaning of Alice because it is not a long-prevalent and fundamental practice, no matter how widespread, in comparison to the abstract ideas of risk-hedging and intermediated settlement relied upon by the Alice court, which have been in widespread use for many centuries throughout the world. Furthermore, the claims take the unconventional steps that confine the claim to a particular useful application; by way of example: specifically making the information created by use of the invention available to a system that has a specific purpose. Hence, the inventive concept claimed here about using an invitation creation and management system to govern permissions around the exchange of patient created health data is a revolutionary concept that amounts to significantly more than applying well known methods to a computer function.

### BRIEF SUMMARY OF THE INVENTION

In some embodiments, the invention comprises computer automated methods and systems to allow a health care provider or other Covered Entity as defined by the Health Insurance Portability and Accountability Act of 1996 (“HIPAA”) to invite a patient to share specific types of patient created health data with him and for the patient to be able to accept or reject such invitations. Furthermore, in some embodiments, the invention allows either health care providers or patients to revoke previously granted permissions to the other party to send or receive patient created health data. These permissions and their statuses are made available to a system that facilitates the communication of patient created data between patients and providers.

### BRIEF DESCRIPTION OF THE SEVERAL VIEWS OF THE DRAWINGS

FIG. 1 and FIG. 2 illustrate non limiting examples of how a provider enters the identifying information for a patient from whom he wishes to receive patient created health data. The provider enters this information into a web browser invitation form generated by a service computer connected to the provider computer via a communications network.

FIG. 3 illustrates a non limiting example of how a provider creates an invitation to a patient to share the selected types of patient created health data by selecting an “Invite” button on the invitation form he just filled in and as illustrated in FIG. 1 and FIG. 2.

FIG. 4 illustrates a non limiting example of some of the pathways the message containing said invitation might follow to arrive at the service computer running the application using the invention.

FIG. 5 illustrates a non limiting example of how said invitation might travel from the service computer housing the application to the patient as well as a non limiting example of how a Uniform Resource Locator (“URL”) linking to said invitation might manifest itself for the patient's consideration in a web browser viewable by the patient.

FIG. 6 and FIG. 6B illustrate non limiting examples of how said invitation might look to the patient and the actions available to the patient.

FIG. 7 illustrates a non limiting example of how said patient response to said invitation might be registered in a database connected to a software application running on a service computer that manages and enforces the business rules around sharing of said patient created data among patients and providers.

FIG. 8 illustrates a non-limiting block schematic diagram that depicts a machine in the exemplary form of a computer system within which a set of instructions for causing the machine to perform any of the herein disclosed methodologies and processes.

FIG. 9 illustrates a non limiting example of a system for supporting invitations to share patient created data, acceptances of said invitations and subsequent revocations of said invitations and acceptances, in part or in whole.

FIG. 10a illustrates a non limiting example of a user interface on the physician's computer that is informed by the service computer housing the application using the invention whereby the physician can view the status of previous invitations and elect to revoke said invitations in part or in whole at a time subsequent to the time the invitation was originally made.

FIG. 10b illustrates a non limiting example of the provider's instructions to stop sharing data being sent to the service computer running the application using the invention where said request is registered in a database attached to said service computer.

FIG. 11 illustrates a non limiting example of how said patient may initiate a request to change the status of permissions regarding his sharing of patient created health data with one or more providers.

FIG. 12 illustrates a non limiting example of how said patient receives a response to said request containing a URL for navigation to a user interface displaying the status of said patient's permissions regarding sharing patient created data with providers.

FIG. 13 illustrates a non limiting example of said user interface which includes an option for the patient to stop sharing data which heretofore has been shared. The patient may tap the button labeled “STOP” next to the data that the patient wishes to stop sharing.

FIG. 14 illustrates a non limiting example of how the patient's instructions to stop sharing said data is sent to the service computer running the application using the invention where said request is registered in a database attached to said service computer.

FIG. 15 illustrates a non-limiting example of the status of invitations being made available to a messaging system that facilitates the communication of patient created data between patients and providers.

### DETAILED DESCRIPTION OF THE INVENTION

This section describes a preferred embodiment of the invention in a non limiting fashion.

Definitions

As used herein, the term “patient created data” or “patient created health data” or “remote patient data” means data that is conveyed by a patient into a computer or other data entry device or computed or read from a patient's body or actions by a computer or other device capable of reading such data outside of the business premises of a health care provider or other covered entity. A non limiting example of patient created data is a patient's blood pressure reading taken at the patient's home and read by a computer located at the patient's home.

As used herein the term “mapping” shall generally mean the process by which something (such as data) is taken from a state where it is ungrouped or unorganized or unassociated with other data and then grouped and organized and associated to other data. One embodiment of mapping is the process of taking an electronic message containing data about a patient's health and grouping it with other data about that patient residing in one or more electronic health records.

As used herein, the term “computer” generally refers to a machine, apparatus, or device that is capable of accepting and performing logic operations derived from software code.

The term “software”, “software code” or “computer software” refers to any set of instructions operable to cause a computer to perform an operation. Software code may be operated on by a “rules engine” or processor. Thus, the methods and systems of the present invention may be performed by a computer based on instructions received by computer software.

As used herein the terms “provider” or “health care provider” shall mean a covered entity or business associate as defined by the Health Insurance Portability and Accountability Act of 1996 (“HIPAA”) including without limitation physicians, their employees or agents or any person or persons or entities involved in supporting or managing the health care of a patient.

As used herein, the term “invitation” shall mean an offer to share or receive patient health data from one entity or person to another entity or person. An invitation includes any metadata about that invitation such as its status (e.g. “pending”, “accepted”, “revoked”, “denied”).

The term URL means Uniform Resource Locator (also known as a web address, particularly when used with HTTP) which is a specific character string that constitutes a reference to a resource.

As used herein, the term “metadata” means data about data. Invitation status, invitation expiration data and an identifier of the provider making the invitation are examples of invitation metadata.

As used herein, the term “provider identifier” means a data element or date elements used to identify a provider such as a National Provider Identifier (“NPI”).

As used herein, the term “patient identifier” means a data element or data elements used to identify a patient such as a medical record number or mobile phone number.

As used herein the terms “data network” and “communications network” shall each mean an infrastructure capable of connecting one or more computers either using wires or wirelessly allowing them to transmit and receive data. Non-limiting examples of data networks may include the Internet and Intranets including but not limited to wifi networks or wireless cellular networks (e.g. 3G and 4G LTE). To the extent Protected Health Information as defined by HIPAA is being transmitted, these networks may be capable of sending messages in a secure/encrypted manner.

As used herein, the term “database” is an organized collection of data. The data in a database are typically organized to model relevant aspects of reality (for example, the organization of information about a patient's health), in a way that supports processes requiring this information. One example of a database is a digital collection of patient information such as patient health records relating to a set of patients. For the purposes of the present disclosure, a database may be stored on a server or other computer and accessed through a data network (e.g., the database is in the cloud) or alternatively in some embodiments the database may be stored on a directly accessible computer itself (i.e., local storage).

In some embodiments, the invention comprises computer implemented methods and systems using (i) a web based user interface available to health care providers, (ii) a database or databases of patient information, provider information data types and statuses of invitations, (iii) a patient computer, (iv) a provider computer and (v) a service computer running an application executing instructions to support the methods described herein.

In some embodiments, when a provider wishes to invite a patient to share patient created data, he accesses a web based user interface and enters the patient's name, mobile phone number, medical record number and types of patient created data to be shared and selects a submit button, creating an invitation request.

In some embodiments, said invitation request is sent via a communications network to a service computer running a software application using the invention and connected to a database.

In some embodiments, metadata of the invitation including provider and patient and health data type identifiers as well the status of the invitation are registered in a database connected to a software application using the invention.

In some embodiments, the provider's identifier is registered with said database as is the patient's identifier, for example, the patient's mobile phone number.

In some embodiments, a text message (also known as an SMS) notification is sent to the patient's mobile phone number with a URL link to a web page containing the details of the invitation.

In some embodiments, the patient taps on the URL in the text message which opens a user interface on the patient's mobile phone containing the details of the invitation.

In some embodiments, the details of the invitation presented on the user interface may include information about the provider's identity and the types of data the provider has invited the patient to share.

In some embodiments, the patient reviews the details of the information and selects an affirmative response to agree to share his patient created data with the provider.

In some embodiments, the patient may select to share some types of patient created data but not share other types of patient created data.

In some embodiments, upon acceptance by said patient of said provider's invitation, the invention causes the status of said invitation to be updated accordingly in a database connected to a service computer running the application using the invention and makes available said status of said invitation to a messaging system facilitating the communication of patient created data between patients and providers.

Now, at some future date, said provider may determine that he no longer wishes to receive certain patient created data from said patient. In some embodiments, said provider may access a web based user interface to view the types of patient created data currently being shared by said patient with said provider. In some embodiments, said provider may select an action on the user interface to stop receiving a subset of the types of patient created data currently being shared with said patient by revoking a previously made invitation to said patient in part or in whole.

In some embodiments, upon submission of said request to stop sharing patient created data, said request is registered in a database connected to a software application running on a service computer using the invention. Subsequently, the application makes the updated status of said invitation available to a messaging system facilitating the communication of patient created data between patients and providers.

Similarly, in some embodiments, at some future date, said patient may determine that he no longer wishes to share certain patient created data with said provider. In some embodiments, said patient may send a text message to the service computer running the application using the invention to request a URL that will direct said patient to a web page where he may view the patient created data currently being shared with said provider and revoke his prior approval to share data with said provider in part or in whole.

In some embodiments of the invention, the patient may choose to revoke his permission to share a subset of the data types shared with said provider.

In some embodiments, upon submission of said request to revoke a previous agreement to share patient created data, said request is registered in a database connected to a software application using the invention in which the statuses of invitations to share such data are updated accordingly. Subsequently, the application makes said request available to a messaging system facilitating the communication of patient created data between patients and providers.

In some embodiments, the invention allows the patient to accept invitations to share patient created data from multiple providers and allows a provider to send invitations to share patient created data to multiple patients.

Computer Implementation

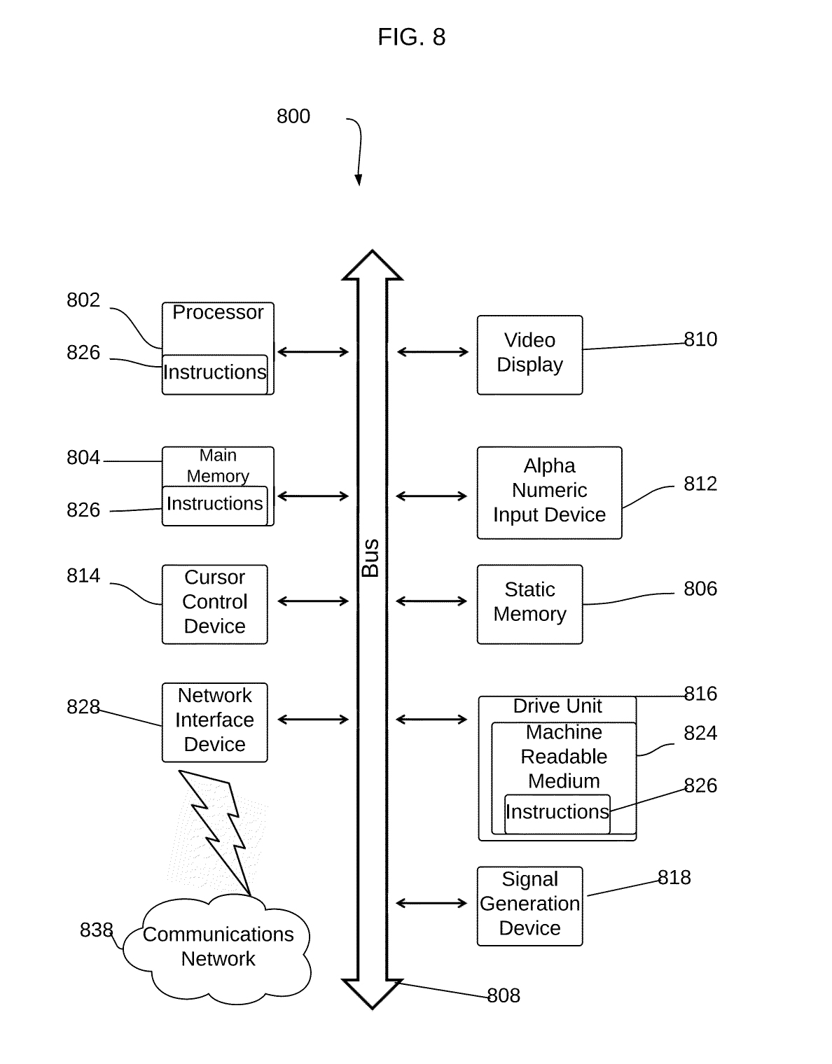

FIG. 8 is a non-limiting block schematic diagram that depicts a machine in the exemplary form of a computer system 800 within which a set of instructions for causing the machine to perform any of the herein disclosed methodologies and processes. In alternative embodiments, the machine may comprise or include a network router, a network switch, a network bridge, personal digital assistant (PDA), a cellular telephone, a smart phone, a computer tablet, a Web appliance or any machine capable of executing or transmitting a sequence of instructions that specify actions to be taken.

The computer system 800 includes a processor 802, a main memory 804 and a static memory 806, which communicate with each other via a bus 808. The computer system 800 may further include a display unit 810, for example, a liquid crystal display (LCD) or a cathode ray tube (CRT). The computer system 800 also includes an alphanumeric input device 812, for example, a keyboard; a cursor control device 814, for example, a mouse; a disk drive unit 816, a signal generation device 818, for example, a speaker, and a network interface device 828.

The disk drive unit 816, if included, includes a machine-readable medium 824 on which is stored a set of executable instructions, i.e. software, 826 embodying any one, or all, of the methodologies described herein below. The software 826 is also shown to reside, completely or at least partially, within the main memory 804 and/or within the processor 802. The software 826 may further be transmitted or received over a network 830 by means of a network interface device 828.

In contrast to the system 800 discussed above, a different embodiment uses logic circuitry instead of computer-executed instructions to implement processing entities. Depending upon the particular requirements of the application in the areas of speed, expense, tooling costs, and the like, this logic may be implemented by constructing an application-specific integrated circuit (ASIC) having thousands of tiny integrated transistors. Such an ASIC may be implemented with CMOS (complementary metal oxide semiconductor), TTL (transistor-transistor logic), VLSI (very large systems integration), or another suitable construction. Other alternatives include a digital signal processing chip (DSP), discrete circuitry (such as resistors, capacitors, diodes, inductors, and transistors), field programmable gate array (FPGA), programmable logic array (PLA), programmable logic device (PLD), and the like.

It is to be understood that embodiments may be used as or to support software programs or software modules executed upon some form of processing core (such as the CPU of a computer) or otherwise implemented or realized upon or within a machine or computer readable medium. A machine-readable medium includes any mechanism for storing or transmitting information in a form readable by a machine, e.g. a computer. For example, a machine readable medium includes read-only memory (ROM); random access memory (RAM); magnetic disk storage media; optical storage media; flash memory devices; electrical, optical, acoustical or other form of propagated signals, for example, carrier waves, infrared signals, digital signals, etc.; or any other type of media suitable for storing or transmitting information.

System Implementation

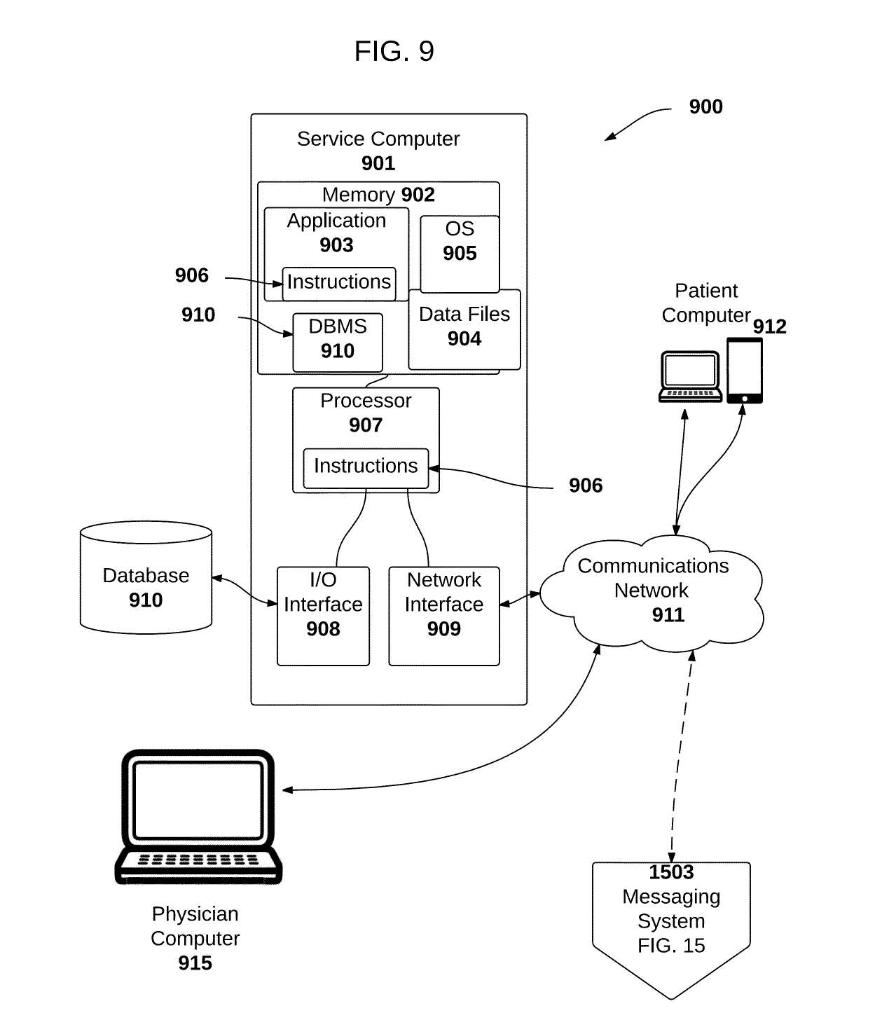

A non limiting example of a system 900 for supporting invitations to share patient created data, acceptances of said invitations and subsequent revocations of said invitations and acceptances will now be described illustratively with respect to FIG. 9. As shown in FIG. 9, the system 900 may include a service computer 901 housing the application 903, a physician computer 915, and a patient computer 912, which are each configured for accessing and reading associated computer-readable media having stored thereon data and/or computer-executable instructions for implementing the various methods of the invention. Generally, network devices and systems, including the one or more service computers 901,one or more physician computers 915, and one or more patient computers 912 have hardware and/or software for transmitting and receiving data and/or computer-executable instructions over one or more communications links or networks. These network devices and systems may also include any number of processors for processing data and executing computer-executable instructions, as well as other internal and peripheral components that are well known in the art. By executing computer-executable instructions, each of the network devices may form a special purpose computer or particular machine. As used herein, the term “computer-readable medium” may describe any form of memory or memory device.

As shown in FIG. 9, the one or more service computers 901 housing the application 903, physician computers 915, and patient computers 912 may be in communication with each other via a communications network 911, which as described below can include one or more separate or shared private and public networks, including the Internet or a publicly switched telephone network. Each of these components—the one or more service computers 901 housing the application 903, physician computers 915, and patient computers 912—will now be discussed in further detail.

First, the patient computer 912 may be associated with one or more patients according to an example embodiment of the invention. The patient computer 912 may be any processor-driven device, such as a desktop computer, laptop computer, handheld computer, commercial server and the like. In addition to having processor(s), the physician computer may further include memory, input/output (“I/O”) interface(s), and network interface(s). The memory may store data files and various program modules, such as an operating system (“OS”) and a client module. The memory may be any computer-readable medium, coupled to the processor, such as RAM. ROM, and/or a removable storage device for storing data files and a database management system (“DBMS”) to facilitate management of data files and other data stored in the memory and/or stored in separate databases. The OS may be, but is not limited to, Microsoft Windows®, Apple OSX™, Unix, Linux or a mainframe operating system. The patient computer, including a dedicated program, interacts with the service computer, 901, to provide the service computer 901, via a communications network, 909, the data elements and business rules associated with the methods described herein. For example, the patient computer 912, may convey to the service computer, 901, via a communications network, 911, data elements including but not limited to the identifier of a provider with which the patient has agreed to share patient created data and specific characteristics of the patient created data. It will be appreciated that while the patient computer 912 has been illustrated as a single computer or processor, the patient computer 912 may be comprised of a group of computers or processors, according to an example embodiment of the invention.

Next, the physician computer 915 may be associated with one or more covered entities, including a physician group, according to an example embodiment of the invention. The physician computer 915 may be any processor-driven device, such as a desktop computer, laptop computer, handheld computer, commercial server and the like. In addition to having processor(s), the physician computer may further include memory, input/output (“I/O”) interface(s), and network interface(s). The memory may store data files and various program modules, such as an operating system (“OS”) and a client module. The memory may be any computer-readable medium, coupled to the processor, such as RAM, ROM, and/or a removable storage device for storing data files and a database management system (“DBMS”) to facilitate management of data files and other data stored in the memory and/or stored in separate databases. The OS may be, but is not limited to, Microsoft Windows®, Apple OSX™, Unix, Linux or a mainframe operating system. The physician computer software, including a dedicated program, interacts with the service computer, 901, to provide the service computer 901, via a communications network, 911, invitation requests and invitation revocations. For example, the physician computer 915, may convey to the service computer, 901, via a communications network, 911, data elements including but not limited to identifiers of some or all of the health data for a particular patient that the provider would like to invite said patient to share. It will be appreciated that while the physician computer 915 has been illustrated as a single computer or processor, the physician computer 915 may be comprised of a group of computers or processors, according to an example embodiment of the invention. The service computer housing the application 901 includes, but is not limited to, any processor-driven device that is configured for receiving, processing, and fulfilling requests from a physician computer 915, relating to invitations to share data or other activities. The service computer 901 may include a processor 907, memory 902, input/output (“I/O”) interface(s) 908, and a network interface 909. The memory 902 may be any computer-readable medium, coupled to the processor 907, such as RAM, ROM, and/or a removable storage device for storing data files 904 and a database management system (“DBMS”) 910 to facilitate management of data files 904 and other data stored in the memory 902 and/or stored in one or more databases 910. The memory 902 may store data files 904 and various program modules, such as an operating system (“OS”) 905, a database management system (“DBMS”) 910, and the application 903. The OS 905 may be, but is not limited to, Microsoft Windows®, Apple OSX™, Unix, or a mainframe operating system. Instructions 906 to carry out the functions described herein may reside within the memory 902 and/or the application 903 and/or the processor 907.

The application module 903 may receive, process, and respond to invitation requests or invitation revocation requests from the physician computer 915, and may further receive, process, and respond to data from the patient computer 912 including acceptances of requests and requests to revoke previously approved invitations from covered entities to share patient created data. The database 910 may be one or more databases operable for storing information including but not limited to a directory of covered entities and patients, types of patient health data and statuses of invitations, acceptances and revocations.

As also illustrated in FIG. 9, the service computer 901 may include or otherwise be in communication with a service application 903. The application module 903 may include business rules and instructions, perhaps stored in a database 910, for determining whether one or more invitation requests received from a physician computer 915 should be sent to certain patients. If the service application 903 determines that one or invitation requests should be responded to by making invitations available to patients, said invitations may be generated and made available via communications network 911 by (i) sending a message to the patient computer 912 or (ii) allowing them to be viewed via a web browser in the patient computer 915.

The application module 903 may be implemented as computer-implemented instructions of the memory 902 of the service computer 901. Alternatively, the application module 903 may also be implemented as computer-implemented instructions of a memory of a separate processor-based system that operates in tandem with the service computer 901, according to an example embodiment of the invention. It will be appreciated that while the service computer 901 has been illustrated as a single computer or processor, the service provider computer 901 may be comprised of a group of computers or processors, according to an example embodiment of the invention.

The communications network 911 may include any telecommunication and/or data network, whether public, private, or a combination thereof, including a local area network, a wide area network, an intranet, an internet, the Internet, intermediate hand-held data transfer devices, a publicly switched telephone network (PSTN), and/or any combination thereof and may be wired and/or wireless. The communications network 911 may also allow for real-time, off-line, and/or batch transactions to be transmitted between or among the service computer 901, and/or the patient computer 912 and/or the physician computer 915. Due to network connectivity, various methodologies as described herein may be practiced in the context of distributed computing environments. It will also be appreciated that the communications network 911 may include a plurality of networks, each with devices such as gateways and routers for providing connectivity between or among networks 911. Instead of or in addition to a network 911, dedicated communication links may be used to connect the various devices in accordance with an example embodiment of the invention. For example, the service computer 901 may form the basis of network 911 that interconnects the physician computer 915 and the patient computer 912.

Generally, each of the memories and data storage devices, such as the memory 902 and the database 910, and/or any other memory and data storage device, can store data and information for subsequent retrieval. In this manner, the system 900 can store various received or collected information in memory or in a database associated with one or more physician computers 915, patient computers 912, and/or service computers 901. The memories and databases can be in communication with each other and/or other databases, such as a centralized database, or other types of data storage devices. When needed, data or information stored in a memory or database may be transmitted to a centralized database capable of receiving data, information, or data records from more than one database or other data storage device. In other embodiments, the databases shown can be integrated or distributed into any number of databases or other data storage devices. In one example embodiment, for security, the service computer 901 (or any other entity) may have a dedicated connection to the database 910, as shown; though, in other embodiments, the service computer 901 or another entity may communicate with the database 910 via a communications network 911.

Suitable processors, such as the processor 907 of the service computer 901, processor of the physician computer 915, and/or processor of the patient computer 912, respectively, may comprise a microprocessor, an ASIC, and/or a state machine. Example processors can be those provided by Intel Corporation (Santa Clara, Calif.), AMD Corporation (Sunnyvale, Calif.), and Motorola Corporation (Schaumburg, Ill.). Such processors comprise, or may be in communication with media, for example computer-readable media, which stores instructions that, when executed by the processor, cause the processor to perform the elements described herein. Embodiments of computer-readable media include, but are not limited to, an electronic, optical, magnetic, or other storage or transmission device capable of providing a processor with computer-readable instructions. Other examples of suitable media include, but are not limited to, a floppy disk, CD-ROM, DVD, magnetic disk, memory chip, ROM, RAM, a configured processor, all optical media, all magnetic tape or other magnetic media, or any other medium from which a computer processor can read instructions. Also, various other forms of computer-readable media may transmit or carry instructions to a computer, including a router, private or public network, or other transmission device or channel, both wired and wireless. The instructions may comprise code from any computer-programming language, including, for example, C, C++, C#, Visual Basic, Java, Python, Perl, and JavaScript. Furthermore, any of the processors may operate any operating system capable of supporting locally executed applications, client-server based applications, and/or browser or browser-enabled applications.

The system 900 shown in and described with respect to FIG. 9 is provided by way of example only. Numerous other operating environments, system architectures, and device configurations are possible. Other system embodiments can include fewer or greater numbers of components and may incorporate some or all of the functionality described with respect to the system components shown in FIG. 9. As an example, in one example embodiment, the service computer 901 may be implemented as a specialized processing machine that includes hardware and/or software for performing the methods described herein. In addition, the processor and/or processing capabilities of the service computer 901 and/or the application 903, may be implemented as part of the physician computer 915, the patient computer 912, or any combination or portion thereof. Accordingly, embodiments of the invention should not be construed as being limited to any particular operating environment, system architecture, or device configuration.

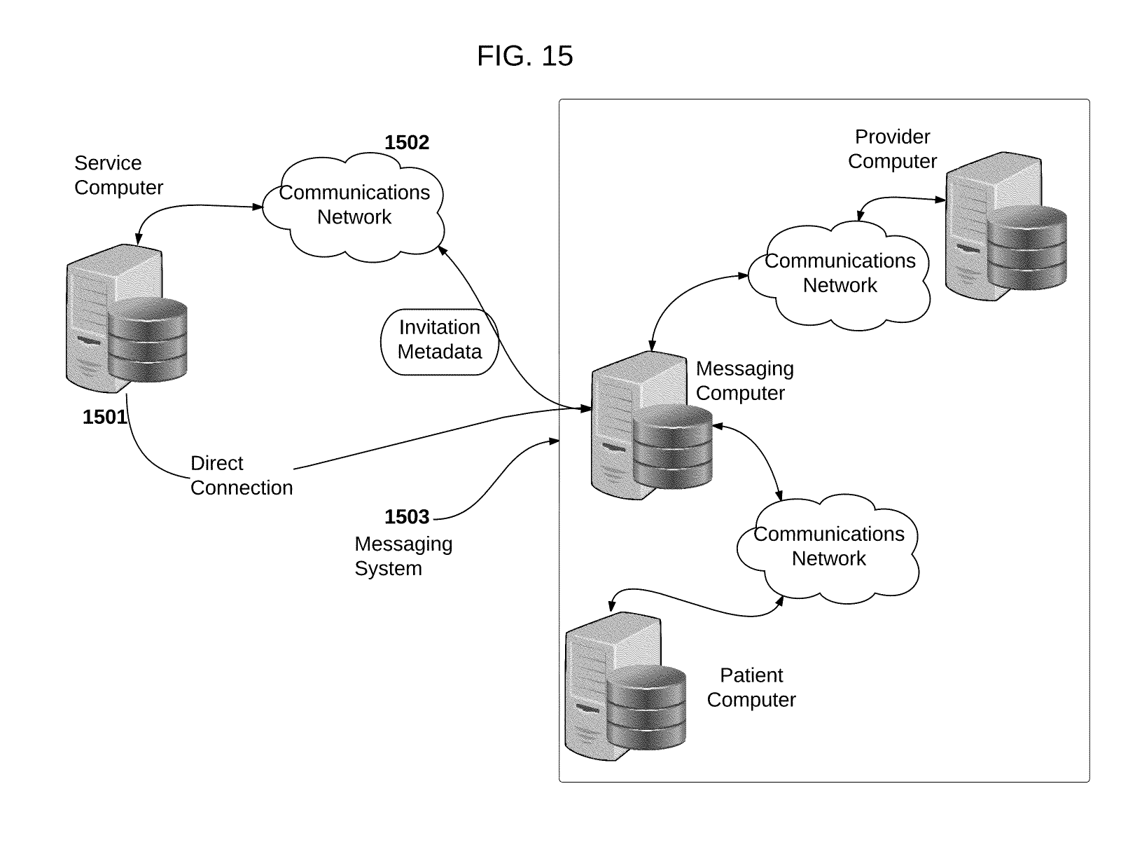

It should be noted that in one embodiment of the invention, a messaging system that facilitates the transmission of patient created data from patients to their health care providers, or agents thereof, communicates with an application using the invention via a communications network such as 1503 in FIG. 15 or directly without the use of a communications network to read business rules surrounding the permissions established by patients and providers regarding the exchange of patient created data between them so said messaging system may enforce said permissions accordingly.

A non limiting illustration of how the invention works follows now. The illustration uses a fictitious diabetic and hypertensive patient (Anne), two fictitious physicians (Dr Welby and Dr Goodgland) and fictitious software applications (iSugar and eBP). While this illustration uses one patient and two physicians, it is not meant to limit the number of physicians, other providers or patients that might use the invention.

Dr. Welby would like to monitor Anne's blood glucose and blood pressure on a daily basis for the next few months. Dr Goodgland would like to monitor Anne's daily blood glucose as well.

Dr. Welby is Anne's primary care physician; Dr. Goodgland, an endocrinologist, is her specialist physician. Anne would like to use the iSugar application that runs on her Apple iPhone to read her blood glucose levels after she measures them with her smart glucometer, a device that can transmit blood glucose data directly to a computer connected to the Internet. iSugar allows patients to enter health information about themselves and transmit it to authorized health care providers via a messaging system. Anne would like to use eBP to measure her blood pressure twice a day. eBP is an application that interacts with a smart blood pressure cuff that can transmit a patient's blood pressure readings to her smartphone via a Bluetooth connection. eBP allows patients to enter health information about themselves and transmit it to authorized health care providers via a messaging system.

To start the process, in a non-limiting illustration, Anne conveys her mobile phone number to the office staff of both physicians who attach this data to Anne's profile in their respective computers or computer systems.

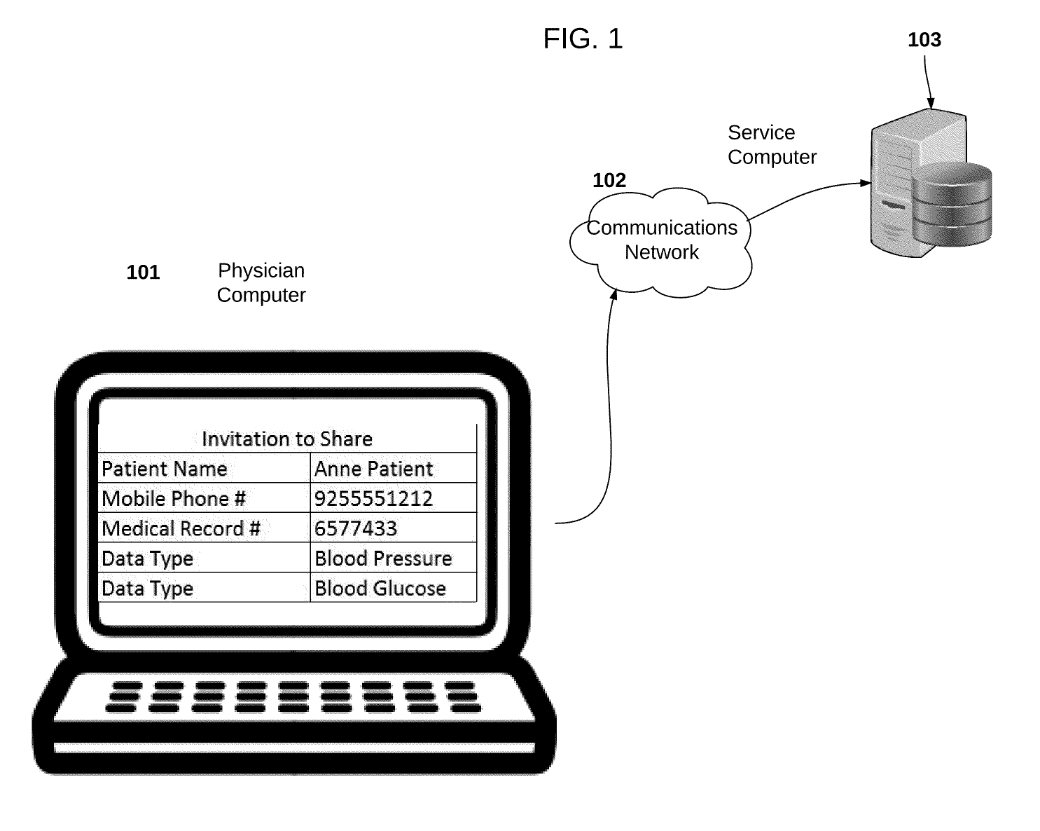

Next, in FIG. 1, Dr Welby uses a web based user interface on the physician's computer 101 to create an invitation to Anne to share her blood pressure and blood glucose data with him. The invitation includes Anne's name, mobile phone number, medical record number and the type of patient created health data Dr. Welby would be willing to receive. The physician computer 101 is connected to a communications network 102 which is connected to a service computer 103.

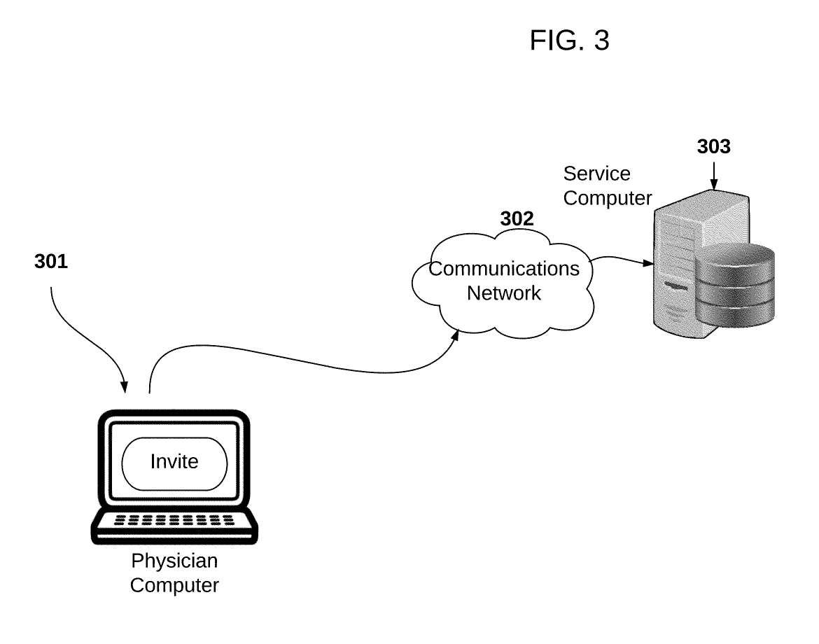

IN FIG. 3, the information entered by Dr. Welby is sufficient for him to create an invitation by selecting an Invite button in the user interface on the physician computer 301. The physician computer 301 is connected to a communications network 302 which is connected to a service computer 303.

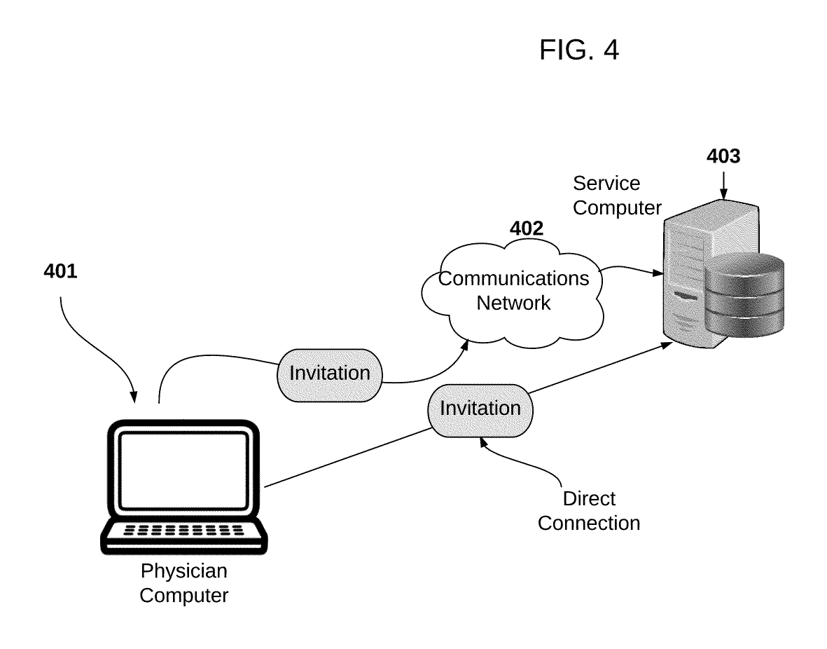

IN FIG. 4, the invitation travels from the physician's computer 401 over a communications network 402 or via direct connection to a service computer 403 that is running an application which contains instructions that facilitate the methods of the invention. The service computer 403 is connected to a database. The application takes the invitation request and writes various data elements regarding the invitation to said database. For example, the data elements might include physician identifier(s) such as a National Provider Identifier (“NPI”), the specific types of patient created health data the physician wants to receive, and patient's identifiers such as a medical record number, mobile phone number, first name, last name and date of birth. Upon receipt of the request from Dr. Welby, the application using the invention establishes an invitation record that has the physician and patient mapped to each other, the types of patient created health data specified if any, and an invitation status. At this point in time, the invitation status is “pending”. Note that a general invitation could be made where the physician does not restrict the types of patient created health data to be shared to any specific type or types.

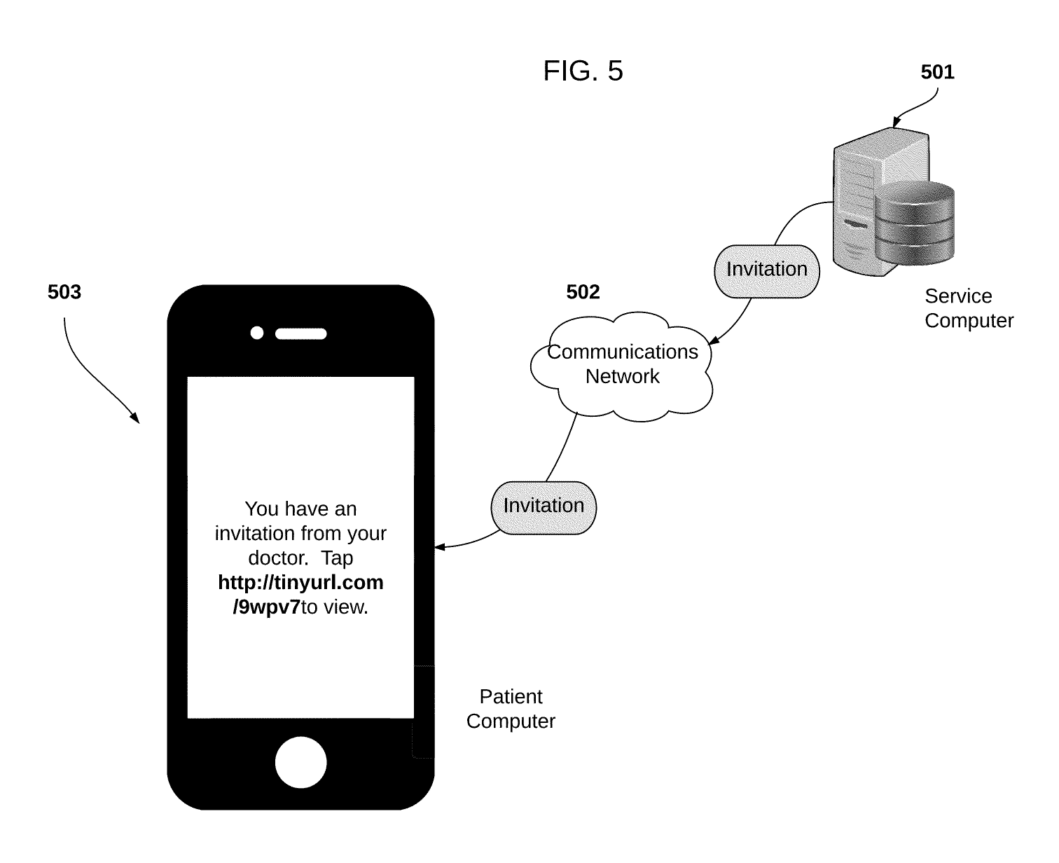

In FIG. 5, the application housing the invention and running on service computer 501 sends a message to Anne's computer 503 over a communications network 502 notifying her of the invitation from Dr. Welby. The invitation contains a URL that, when selected by Anne, opens up a web browser with the details of the invitation.

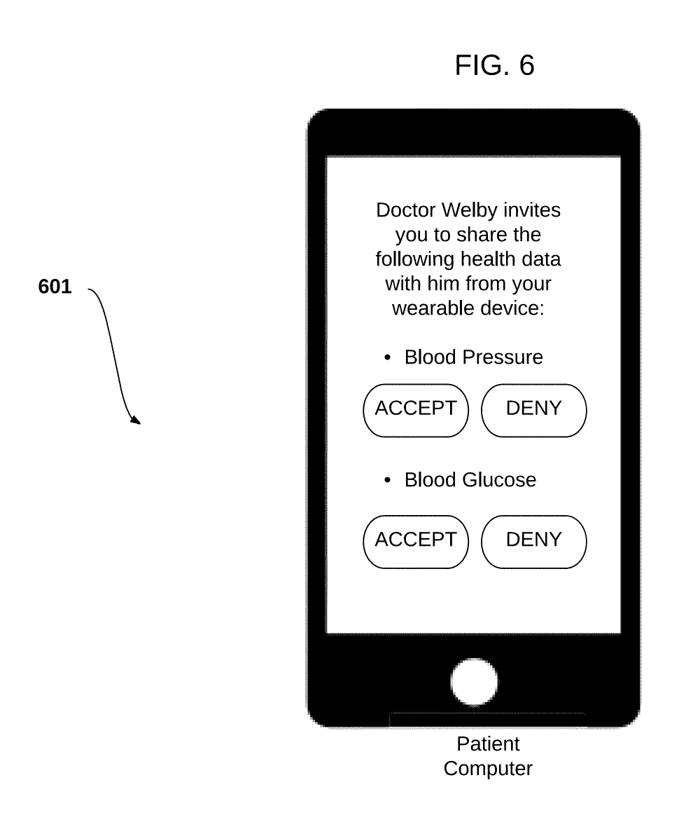

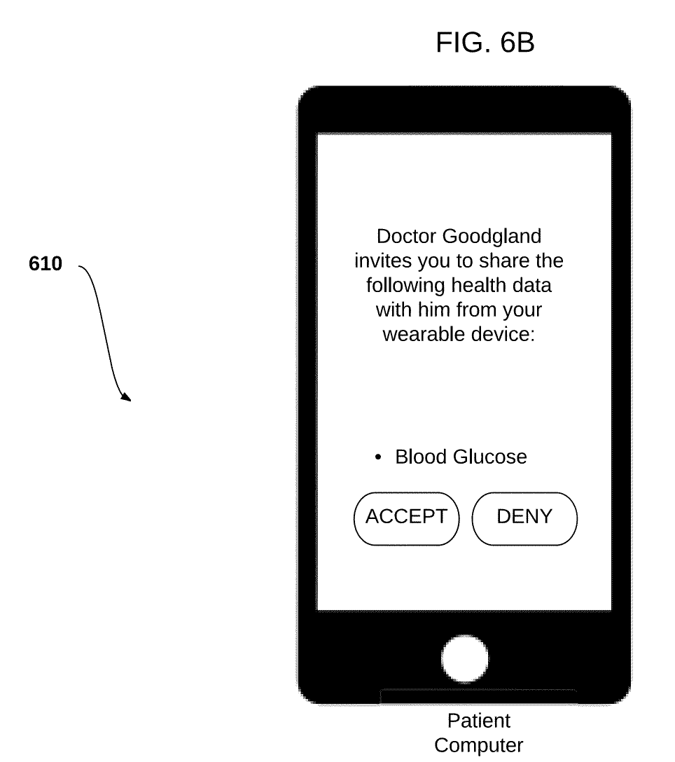

In FIG. 6, Anne, having selected the URL in FIG. 5, is presented with a page on a web browser on her mobile computer 601. The web browser accesses the invitation information in the database connected to the service computer 501 in FIG. 5 and presents the invitation details accordingly. Anne sees that Dr. Welby would like her to share blood pressure and blood glucose information with him. Anne remembers that Dr Goodgland wanted her blood glucose information as well and does not want to share that information type with more than one doctor. On the invitation from Dr. Welby, she selects “approve” for the request to share blood pressure information and “deny” for the request to share blood glucose information.

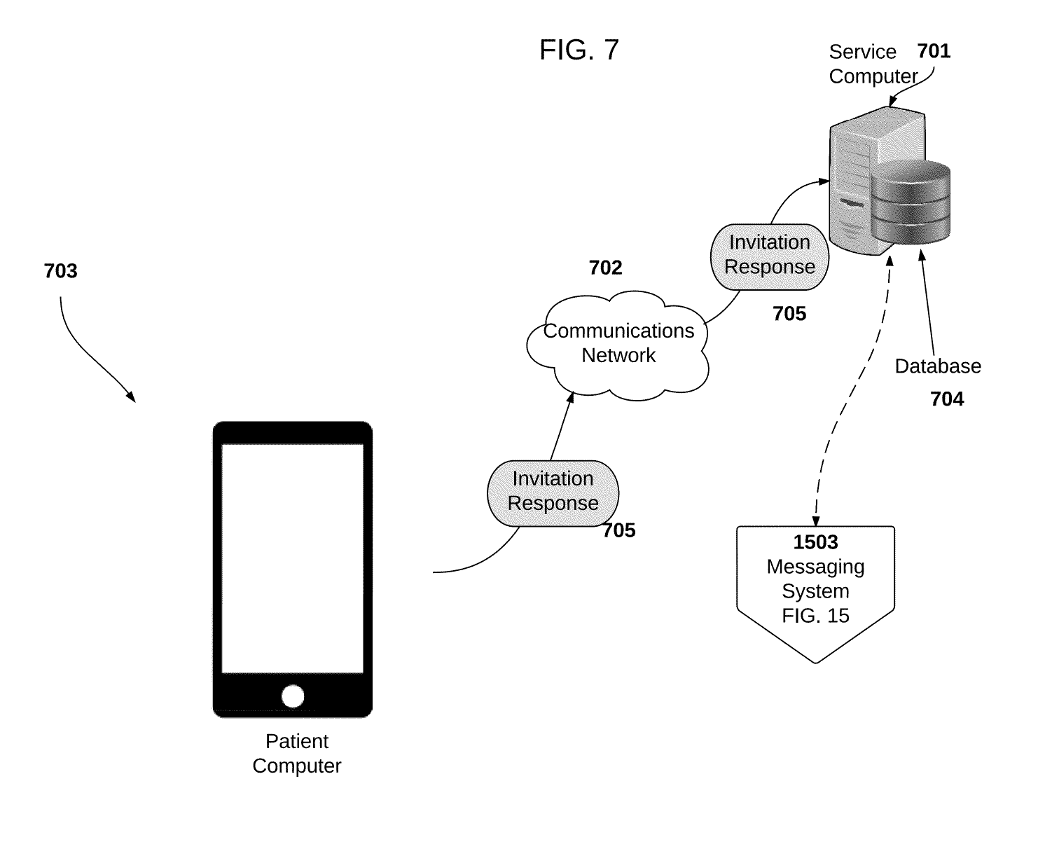

In FIG. 7, Anne's responses 705 are sent via a communications network 702 to a service computer 701 running the application using the invention. There, her responses 705 are registered in a database 704 attached to a service computer 701 running an application using the invention. The status of the invitation from Dr. Welby to Anne is modified as follows: the invitation to share blood pressure information is changed from “pending” to “accepted”; the invitation to share blood glucose information is changed from “pending” to “denied”. These invitations, including physician, patient and health care data identifiers and their updated statuses and are made available to a messaging system 1503 facilitating the communication of patient created health data between patients and providers. Now, going forward, Anne may send her remote patient data about her blood pressure via said messaging system 1503 to Dr. Welby.

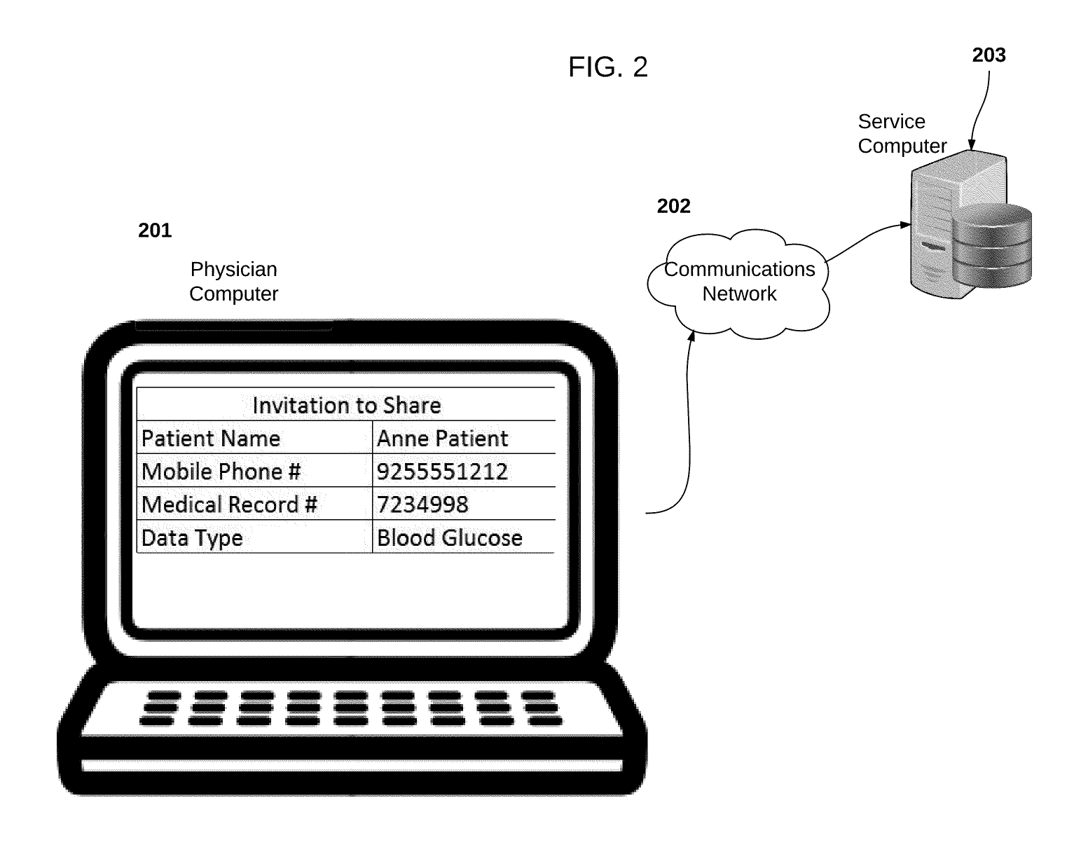

Next, in FIG. 2, Dr. Goodgland uses a web based user interface on a physician computer 201 to create an invitation to Anne to share her blood pressure and blood glucose data with him. The invitation includes Anne's name, mobile phone number, medical record number and the type of health data Dr. Goodgland would be willing to receive. The physician computer 201 is connected to a communications network 202 which is connected to a service computer 203.

In FIG. 3, the information entered by Dr. Goodgland is sufficient for him to create an invitation which he may do by clicking on the Invite button in the user interface using the physician computer 301. The physician computer 301 is connected to a communications network 302 which is connected to a service computer 303.

IN FIG. 4, the invitation travels from the physician computer 401 over a communications network 402 to a service computer 403 that is running an application that contains instructions which facilitate the methods of the invention. The service computer 403 is connected to a database. The application takes the invitation request and writes to the database various data elements regarding the invitation. For example, the data elements might include the physician's identifier(s) such as a National Provider Identifier (“NPI”), the specific types of patient health data the physician wants to receive, and the patient's identifiers such as a medical record number, mobile phone number, first name, last name and date of birth. An invitation record is established that has the physician and patient mapped to each other, the types of health data specified if any, and an invitation status. At this point in time, the invitation status is “pending”. Note that a general invitation could be made where the physician does not restrict the types of health data to be shared to any specific type or types.

In FIG. 5, the application housing the invention and running on service computer 501 sends a message to Anne's computer 503 over a communications network 502 notifying her of the invitation from Dr. Goodgland. The invitation contains a URL that, when selected by Anne, opens up a web browser with the details of the invitation.

In FIG. 6B, Anne, having selected the URL in FIG. 5, is presented with a page on a web browser on her mobile computer 601. The web browser accesses the invitation information in the database connected to the service computer running an application using the invention 501 in FIG. 5 and presents the invitation details accordingly. Anne sees that Dr Goodgland would like her to share blood glucose information with him. On the invitation from Dr. Goodgland, she selects “approve” for the request to share blood glucose information.

In FIG. 7, Anne's responses 705 are sent via a communications network 702 to a service computer 701 running the application using the invention. There, her responses 705 are registered in a database 704 attached to a service computer 701 running an application using the invention. The status of the invitation from Dr. Goodgland to Anne is modified as follows: the invitation to share blood glucose information is changed from “pending” to “accepted”. This invitation, including physician, patient and health care data identifiers and their updated statuses is made available to a messaging system 1501 facilitating the communication of patient created data to providers. Now, going forward, Anne may send her remote patient data about her blood glucose via said messaging system 1501 to Dr. Goodgland.

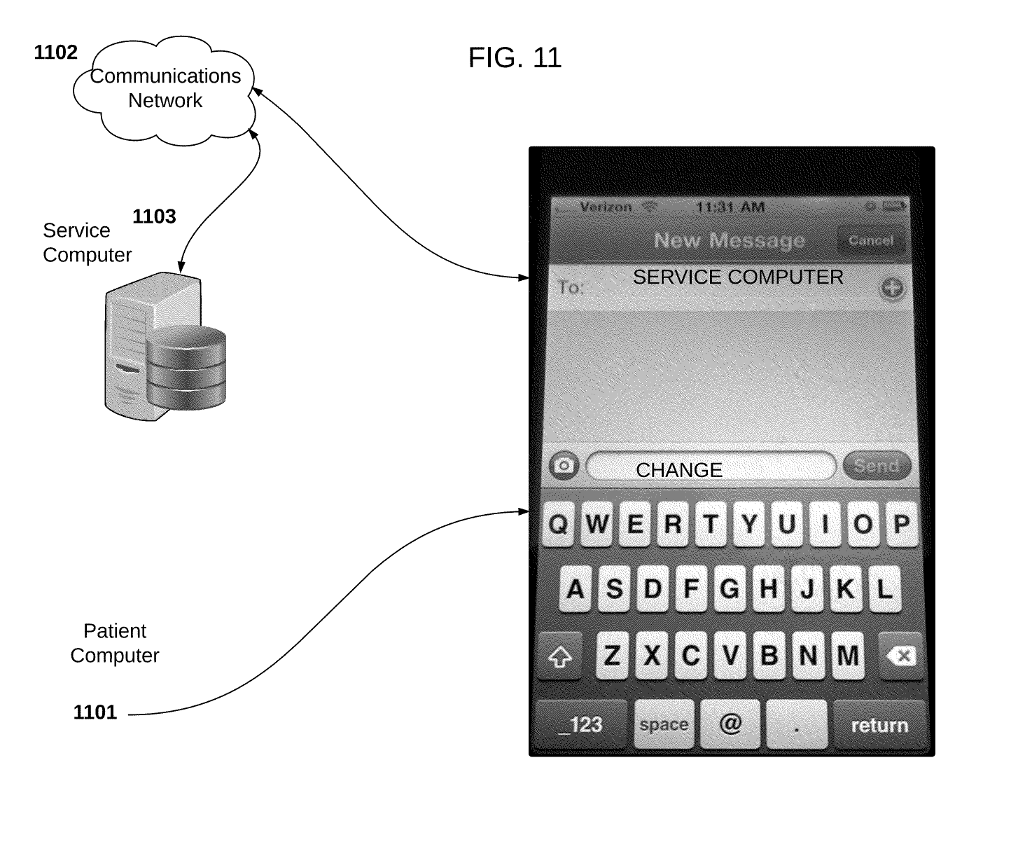

Two months later, Anne is forced to change her health insurance. To her dismay, Dr. Goodgland is not in her new insurance company's provider network. If she continues to see Dr. Goodgland, she will have to pay his fees in full with cash. Therefore, she decides to change endocrinologists and begins to see Dr. Titrate who is in her new insurance company's provider network. At this point, Anne decides she does not want to continue to send her blood glucose information to Dr. Goodgland. In FIG. 11, she uses her patient computer 1101 and sends a message “Change” over a communications network 1102 to the service computer 1103 running the application using the invention. In a non limiting illustration, the message could be sent via Short Message Service (“SMS”) using the SMS short code of the entity running the application using the invention.

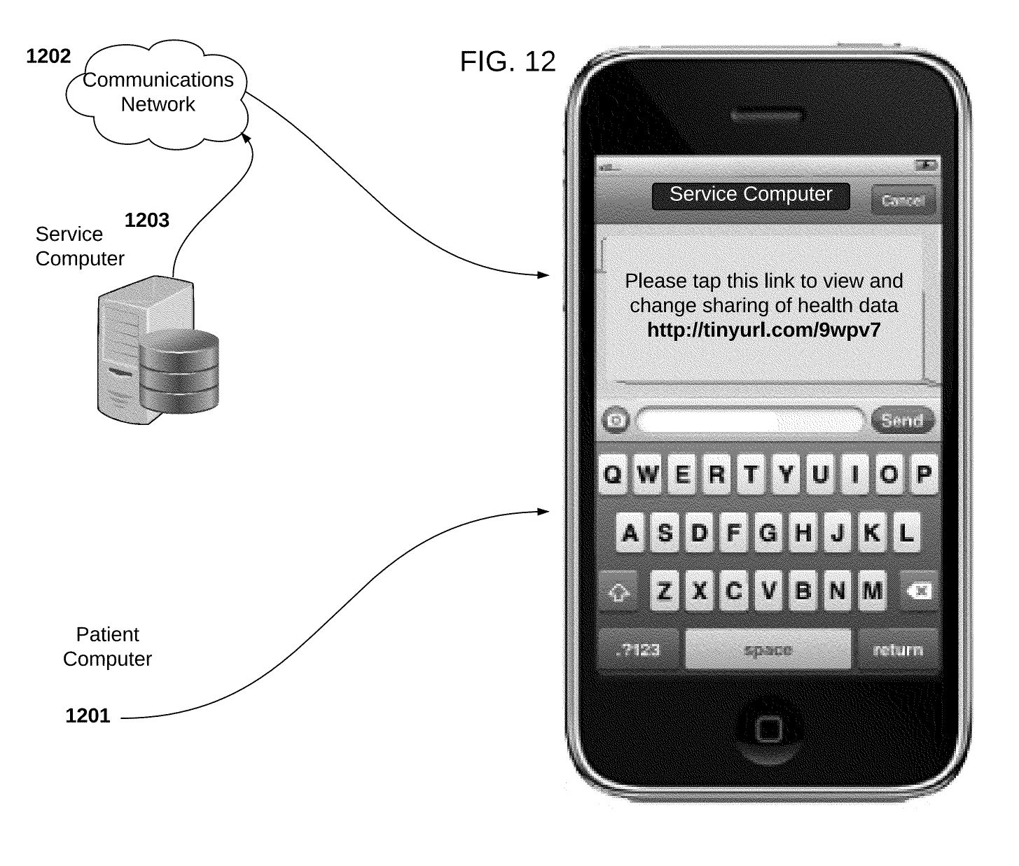

In response, in FIG. 12 she receives back from the service computer 1203 via a communications network 1202 an SMS on her computer 1201 with a URL that takes her to a web browser page where she can view the health care providers to whom she currently has given authorization to receive her patient created health data.

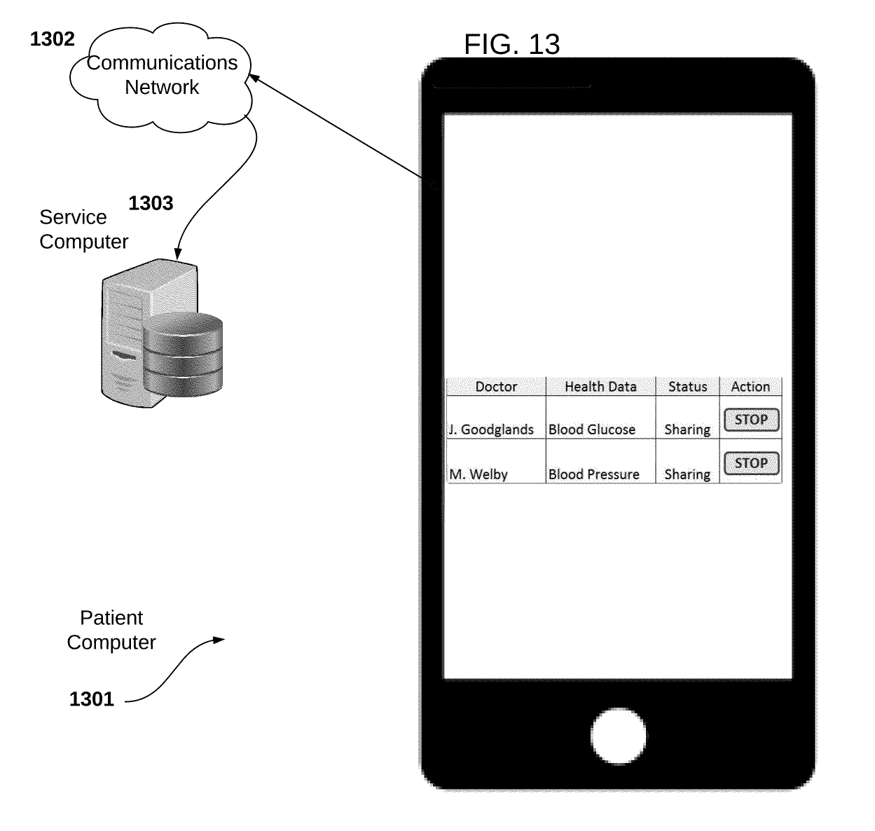

In FIG. 13, the patient computer 1301 displays a non limiting example of such a web browser page which has been rendered using information on the service computer 1303 accessed via a communications network 1302. Next to Dr. Goodgland's name is a selection option labeled “Stop”. She selects “Stop” to create revocation instructions of her previously accepted invitation from Dr. Goodgland to share her blood glucose data.

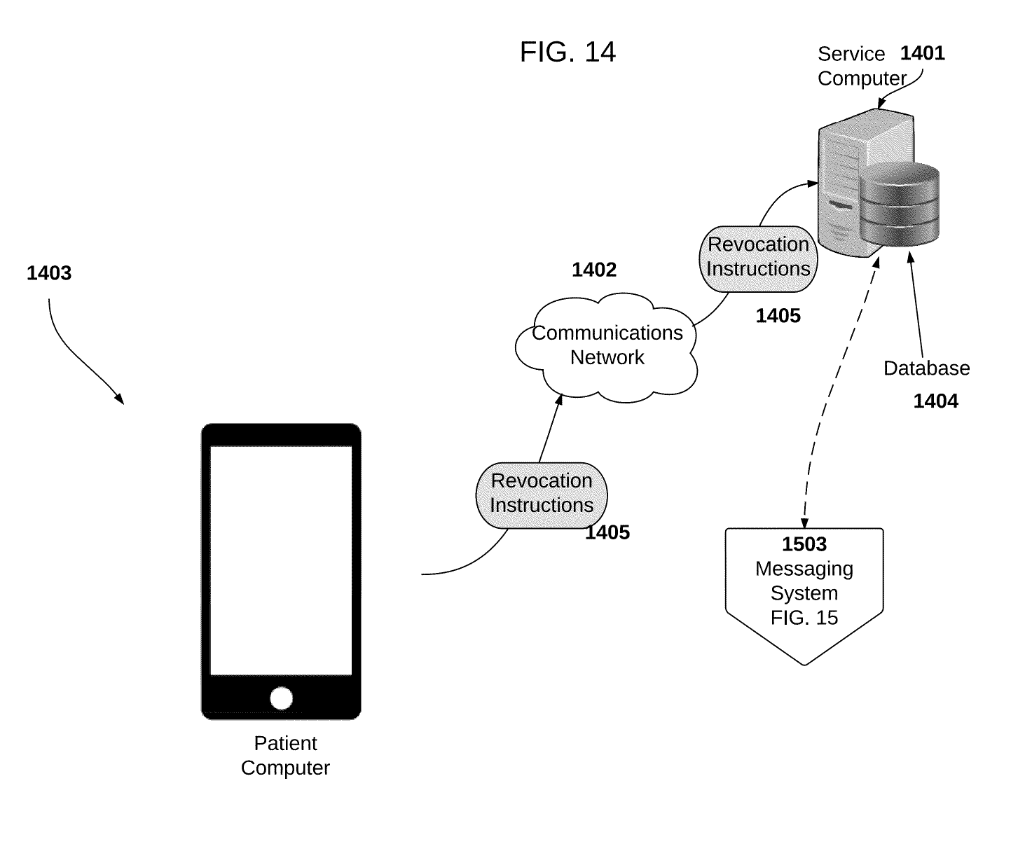

In FIG. 14, Anne's revocation instructions 1405 created with her patient computer 1403 are sent via a communications network 1402 to a service computer 1401 running the application using the invention. There, her selection is registered in a database 1404 attached to said service computer running an application using the invention. In said database 1404, the invitation status to share blood glucose information between Anne and Dr. Goodgland is changed from “accepted” to “revoked”. This status is made available to a messaging 1503 facilitating the communication of patient created data to providers. Now, going forward, Dr. Goodgland is no longer authorized to receive remote patient data from Anne via said messaging system.

Six months later, Dr. Welby is satisfied that Anne's blood pressure is well under control and that she is doing a good job with exercise, diet and taking medication as prescribed. He determines that the health outcomes benefit of receiving future transmissions of Anne's patient created data is low.

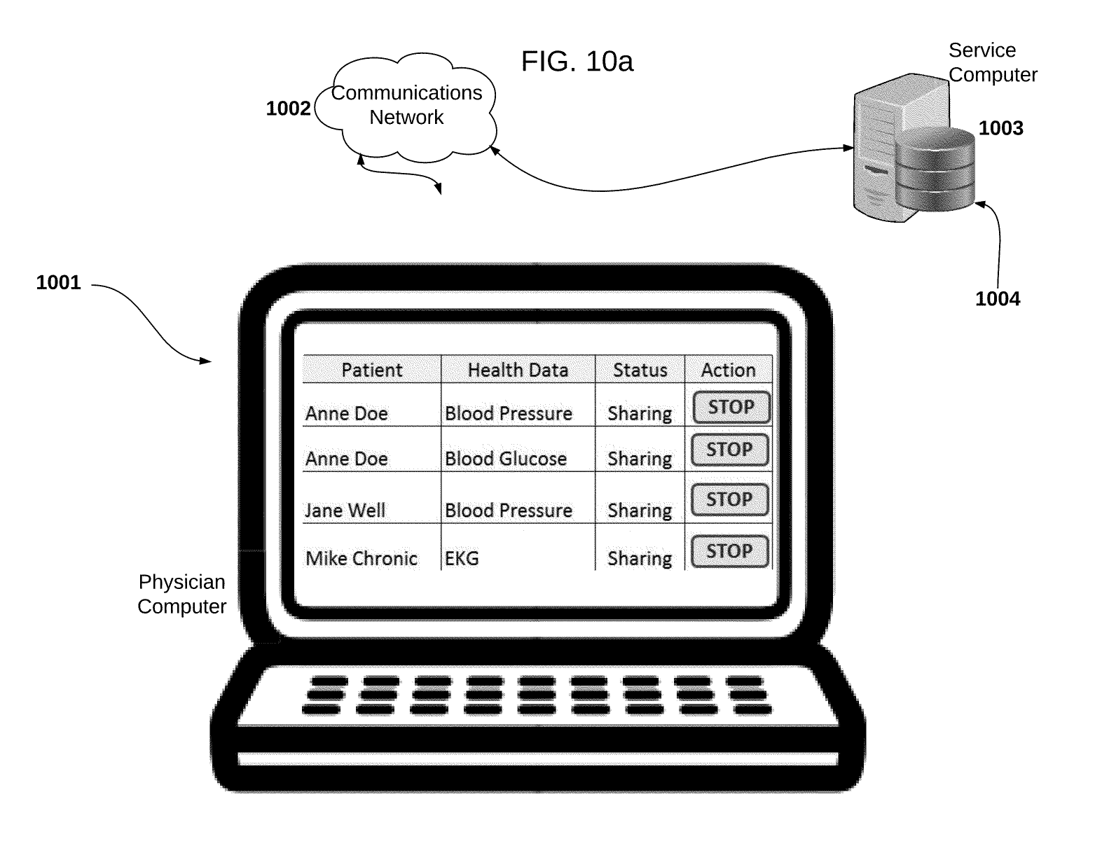

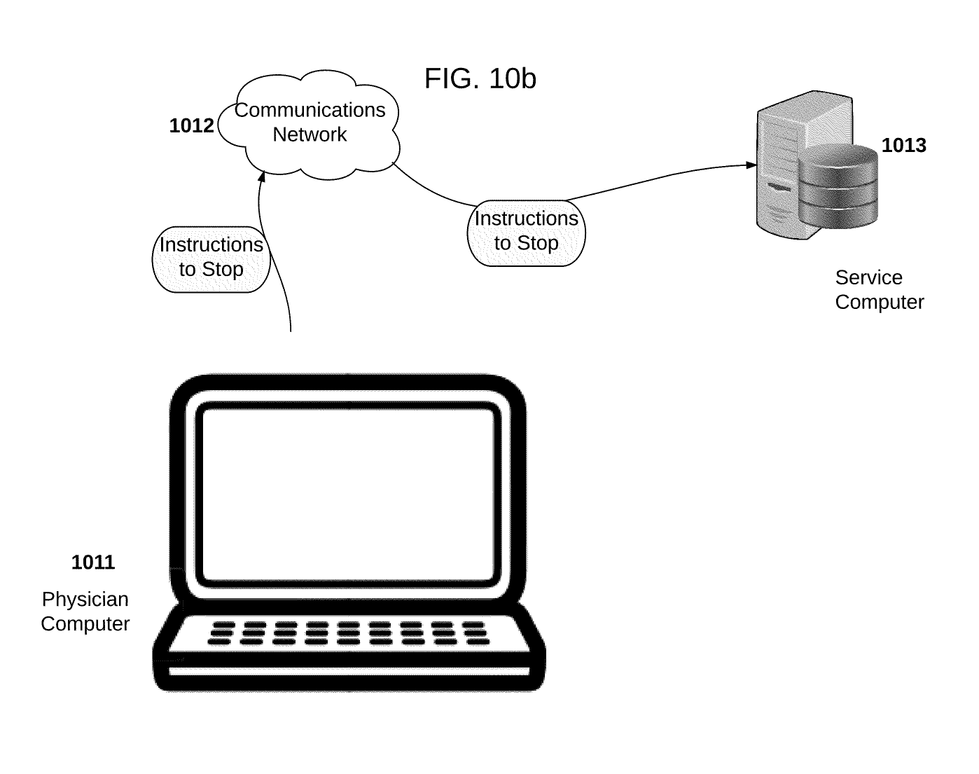

In FIG. 10a, Dr Welby uses a web based user interface on the physician computer 1001 to review the status of the invitation to share her patient created blood pressure data and can see that she is currently authorized to send him patient created blood pressure data. The physician computer 1001 displays a web browser page which has been rendered using information on the service computer 1003 connected to a database 1004 and accessed via a communications network 1002. He selects the “Stop” button next to Anne's name and the blood pressure descriptor. Note that in this non limiting example, Dr. Welby views the statuses of the two different types of health care data he had previously offered to received from Anne—blood glucose and blood pressure—as two separate records. By presenting Dr. Welby with such a view, the application running the invention allows Dr. Welby to terminate the sharing of certain types of health care data types without terminating the sharing of other type of health care data types.

In FIG. 10b, Dr. Welby's selection is sent from the physician computer 1011 via a communications network 1012 to a service computer 1013 housing the application using the invention. In said database 1014, the invitation status to share blood glucose information between Anne and Dr. Goodgland is changed from “accepted” to “revoked”. There, his selection is registered in a database 1014 attached to said service computer and is made available to a messaging system 1503 facilitating the communication of patient created data between patients and providers. Now, going forward, Anne is no longer authorized to send remote patient data to Dr Welby about her blood pressure via said messaging system 1503.

In a non limiting example, the database (for example, 1004 in FIG. 10a) connected to an application on a computer using the invention stores information in a database including identifiers of the patients and health care providers, the states of invitations to share health related data and the responses to said invitations including but not limited to “open”, “expired”, “accepted”, “rejected” and “revoked” as well as the types of health care data for which said invitations have been made.

FIG. 15 illustrates a non-limiting example of how the statuses and data elements of invitations are made available to a messaging system 1503 that facilitates the communication of patient created data from patients to covered entities. The service computer 1501 running an application using the invention makes available via direct connection or a communications network 1502 to said messaging system 1503 the statuses and data elements of invitations to share patient created data between patients and providers.

Note that in a non limiting example, in all figures showing a service computer, a messaging system may be in communications with the service computer using the invention where permissions embodied in the invitations, including their metadata, for the exchange of patient created data between patients and providers are stored. By accessing these invitations and their metadata, the messaging system is able to satisfy the permissions and business rules of both providers and patients regarding the transmission and receipt of such patient created data.

In a non limiting illustration, by adoption of the invention, health care providers are able to govern which patients will be able to send them patient created health data, including certain types of health data, and which patients are at some future date no longer permitted to send them patient created health data.

In a non limiting illustration, by adoption of the invention, patients are able to govern which health care providers are authorized to receive their patient created health data, including certain types of health data, and which health care providers are at some future date no longer authorized to receive their patient created health data.

In a non limiting illustration, using the invention in conjunction with a messaging system 1503 that facilitates the communication of patient created data between patients and providers, health care providers, particularly physicians, will be more likely to to adopt a paradigm whereby they receive and review patient created health data because the volumes of “low value” noisy data that might potentially be sent to said providers will be lower than that without the invention.

In a non limiting illustration, by communicating with the invention, a messaging system such as 1503 in FIG. 15 will be able to satisfy both providers and patients by supporting the business rules of both said patients and said providers regarding permissions to send and receive patient created health data.

### Non Limiting Summary of a Preferred Embodiment

In preferred embodiments, the present invention comprises a computer implemented method, system and a non-transitory, computer-readable storage medium storing computer-executable instructions for allowing health care providers to invite patients to share patient created health data with them via electronic communications, allowing patients to accept or reject said invitations, and allowing health care providers to revoke previously created invitations and patients to revoke previously accepted invitations to facilitate a framework that will foster patient and health care provider adoption of a paradigm in which health care providers can incorporate the receipt, monitoring and review of patient created health data, said method comprising:

creating a set of one or more databases containing logic to store health provider identifiers, patient identifiers, and invitations, including invitation metadata;

receiving from a provider a request to offer an invitation to a patient to share patient created health data;

registering said invitation in one or more said databases;

making available said invitation to said patient;

receiving said patient's response to said invitation;

registering said patient's response to said invitation in one or more said databases and updating the status of said invitation accordingly in said one or more databases;

making available said invitation and invitation metadata to a messaging system that facilitates the communication of patient created health data between patients and providers.

making available status of said invitation including patient response, if any, to said provider;

receiving a request from said provider to revoke a previously made invitation by said provider;

registering said request from said provider to revoke said previously made invitation in one or more databases and updating the status of said invitation accordingly in said one or more databases;

making available provider's revocation of said previously made invitation to a messaging system that facilitates the communication of patient created health data between patients and providers.

making available status of said invitation including patient response, if any to said patient;

receiving a request from said patient to revoke a previously made acceptance of said invitation by said patient;

registering in one or more databases said request from said patient to revoke said previously accepted invitation and updating the status of said invitation accordingly in said one or more databases;

making available patient's revocation of said previously made acceptance of said invitation to a messaging system that facilitates the communication of patient created health data between patients and providers;

Allowing patients and providers to perform any of the actions above using a subset of patient created health data types.

Although the invention is described herein with reference to the preferred embodiment, one skilled in the art will readily appreciate that other applications may be substituted for those set forth herein without departing from the spirit and scope of the present invention. Accordingly, the invention should only be limited by the claims included below.

1. A computer implemented method for allowing providers to invite patients to share patient created data with them via electronic communications and allowing patients to accept or reject said invitations, facilitating a business rule framework that will foster patient and health care provider adoption of a paradigm in which providers will incorporate the monitoring and review of patient created health data into the management of patients' health, said method comprising:
creating a set of one or more databases containing logic to store provider identifiers, patient identifiers, invitations, and invitation metadata;
receiving from a provider or provider's representative an invitation to a patient to share patient created health data;
registering said invitation in said one or more databases;
making available said invitation to said patient;
receiving said patient's response to said invitation;
registering said patient's response to said invitation in one or more databases and updating the status of said invitation accordingly in said one or more databases;
making available said invitation and patient's response to said invitation to a messaging system that facilitates the communication of patient created health data between patients and providers.

2. The method of claim 1, further comprising:
receiving from a provider an invitation to a patient to share a specific type or specific types of patient created health data;

3. The method of claim 1, further comprising:
receiving from an provider a request to offer an invitation with an expiration date to a patient to share patient created health data;

4. The method of claim 1, further comprising:
making available the status of said invitation including patient response, if any, to said provider;
receiving a request from said provider to revoke a previous invitation made by said provider;
registering in one or more databases said request from said provider to revoke said previously made invitation and updating the status of said invitation accordingly in said one or more databases;
making available said invitation to a messaging system that facilitates the communication of patient created health data between patients and providers.

5. The method of claim 4 further comprising:
receiving from a provider or provider's representative a request to revoke in part or in whole a previous invitation to a patient to share a specific type or specific types of patient created health data.

6. The method of claim 1, further comprising:
making available status of said invitation including patient response, if any, to said patient;
receiving a request from said patient to revoke a previously made acceptance of said invitation by said patient;
registering in one or more databases said request from said patient to revoke in part or in whole said previously accepted invitation and updating the status of said invitation accordingly in said one or more databases;
making available said invitation to a messaging system that facilitates the communication of patient created health data between patients and providers.

7. The method of claim 6 further comprising:
receiving from said patient or said patient's representative a request to revoke in part or in whole a previously made acceptance of an invitation to said patient to share a specific type or specific types of patient created health data;

8. A nontransitory, computer-readable storage medium storing computer-executable instructions that allows information to be properly routed to and from and organized in a database for any of managing, reading, recording, and transmitting information relating to invitations regarding the exchange, transmission or sharing of patient created health data between patients and providers, said instructions comprising:
instructions to create a set of one or more databases containing logic to store provider identifiers, patient identifiers and invitations, and invitation metadata.
instructions to receive from a provider an invitation to a patient to share patient created health data;
instructions to register said invitation in said one or more databases;
instructions to make available said invitation to said patient;
instructions to receive said patient's response to said invitation;
instructions to register said patient's response to said invitation in one or more databases;
instructions to make available said invitation and patient's response to said invitation to a messaging system that facilitates the communication of patient created health data between patients and providers.

9. The computer-readable storage medium of claim 8, wherein said instructions further comprise:
an instruction to receive from a provider a request to offer an invitation to a patient to share a specific type or specific types of patient created health data.

10. The computer-readable storage medium of claim 8, wherein said instructions further comprise:
an instruction to receive from a provider or provider's representative a request to offer an invitation with an expiration date to a patient to share patient created health data;

11. The computer-readable storage medium of claim 8, wherein said instructions further comprise:
an instruction to make available status of said invitation including patient response, if any, to said provider;
an instruction to receive a request from said provider to revoke a previous invitation made by said provider;
an instruction to register in one or more databases said request from said provider to revoke said previously made invitation and updating the status of said invitation accordingly in said one or more databases;
an instruction to make available said provider's invitation to a messaging system that facilitates the communication of patient created health data between patients and providers.

12. The computer-readable storage medium of claim 11, wherein said instructions further comprise:
an instruction to receive from a provider a request to revoke in part or in whole a previous invitation to a patient to share a specific type or specific types of patient created health data.

13. The computer-readable storage medium of claim 8, wherein said instructions further comprise:
an instruction to make available status of said invitation including patient response, if any, to said patient;
an instruction to receive a request from said patient to revoke a previously made acceptance of said invitation by said patient;
an instruction to register in one or more databases said request from said patient to revoke said previously accepted invitation and updating the status of said invitation accordingly in said one or more databases;
an instruction to make available updated status of said invitation to a messaging system that facilitates the communication of patient created health data between patients and providers.

14. The computer-readable storage medium of claim 13, wherein said instructions further comprise:
an instruction to receive from said patient or said patient's representative a request to revoke in part or in whole a previously made acceptance of an invitation to said patient to share a specific type or specific types of patient created health data.

15. A system for allowing providers to invite patients to share patient created data with them via electronic communications and allowing patients to accept or reject said invitations to facilitate a business rule framework that will foster patient and provider adoption of a paradigm in which health care providers can incorporate the monitoring and review of patient created health data into the management of the health of their patients, the system comprising:
a communication network;
one or more computers, each computer having a processor, and memory coupled to the processor; and
one or more server computers communicatively coupled to the communication network and the one or more computers;
one or more databases connected to the one or more server computers;
one or more computers having an application stored thereon, the application configured or programmed to receive inputs at the processor creating a set of one or more databases containing logic to store provider identifiers, patient identifiers, invitations, and invitation metadata;
wherein the application is configured or programmed to cause the processor to automatically or upon manual input to receive from a provider a an invitation to a patient to share patient created health data;
wherein the application is configured or programmed to cause the processor to automatically or upon manual input to register said invitation in said one or more databases;
wherein the application is configured or programmed to cause the processor to automatically or upon manual input to make available said invitation to said patient;
wherein the application is configured or programmed to cause the processor to automatically or upon manual input to receive said patient's response to said invitation;
wherein the application is configured or programmed to cause the processor to automatically or upon manual input to register said patient's response to said invitation in one or more databases and updating the status of said invitation accordingly in said one or more databases;
wherein the application is configured or programmed to cause the processor to automatically or upon manual input to make available said invitation and its updated status to a messaging system that facilitates the communication of patient created health data between patients and providers.

16. The system of claim 15, wherein said application is further configured or programmed to cause the processor to automatically or upon manual input to:
receive from a provider or provider's representative a request to offer an invitation to a patient to share a specific type or specific types of patient created health data;

17. The system of claim 15, wherein said application is further configured or programmed to cause the processor to automatically or upon manual input to:
receive from a provider an invitation to a patient with an expiration date to share patient created health data;

18. The system of claim 15, wherein said application is further configured or programmed to cause the processor to automatically or upon manual input to:
make available status of said invitation including patient response, if any, to said provider;
receive a request from said provider to revoke a previous invitation made by said provider;
register in one or more databases said request from said provider to revoke said previously made invitation and updating the status of said invitation accordingly in said one or more databases;
make available said invitation's updated status to a messaging system that facilitates the communication of patient created health data between patients and providers.

19. The system of claim 18, wherein said application is further configured or programmed to cause the processor to automatically or upon manual input to:
receive from an provider a request to revoke in part or in whole a previous invitation to a patient to share a specific type or specific types of patient created health data;

20. The system of claim 15, wherein said application is further configured or programmed to cause the processor to automatically or upon manual input to:
make available status of said invitation including patient response, if any, to said patient;
receive a request from said patient to revoke a previously made acceptance of said invitation by said patient;
register in one or more databases said request from said patient to revoke said previously accepted invitation and updating the status of said invitation accordingly in said one or more databases;
make available said invitation's updated status to a messaging system that facilitates the communication of patient created health data between patients and providers.

21. The system of claim 20, wherein said application is further configured or programmed to cause the processor to automatically or upon manual input to:
receive from said patient or said patient's representative a request in part or in whole to revoke a previously made acceptance of an invitation to a said patient to share a specific type or specific types of patient created health data.
